(19) United States
(12) Patent Application Publication
(10) Pub. No.: US 2016/0161249 A1
(43) Pub. Date: Jun. 9, 2016

(54) METHOD AND DEVICE FOR MEASURING DISPLACEMENT DISTRIBUTION OF AN OBJECT USING REPEATED PATTERN, AND PROGRAM FOR THE SAME

(71) Applicant: NATIONAL INSTITUTE OF ADVANCED INDUSTRIAL SCIENCE AND TECHNOLOGY, Tokyo (JP)

(72) Inventors: Shien RI, Tsukuba-shi (JP); Hiroshi TSUDA, Tsukuba-shi (JP)

(73) Assignee: NATIONAL INSTITUTE OF ADVANCED INDUSTRIAL SCIENCE AND TECHNOLOGY, Chiyoda-ku, Tokyo (JP)

(21) Appl. No.: 14/904,890

(22) PCT Filed: Dec. 5, 2013
(86) PCT No.: PCT/JP2013/082701

§ 371 Date: Jan. 13, 2016

(30) Foreign Application Priority Data
Jul. 18, 2013 (JP) 2013-149340

(51) Int. Cl. G01B 11/16; G01M 5/00

(52) U.S. Cl. CPC G01B 11/165; G01M 5/0091; G01M 5/0041

(57) ABSTRACT

In the present invention, conventional problems that the scheme is not suitable for nano/micro materials or large structures, and that if the scheme is applied to a regular pattern with two or more cycles of arbitrary repetition, a large error is generated are solved by using a higher order frequency of moire fringes generated using an arbitrary regular pattern having one-dimensional or two-dimensional repetition artificially produced on a surface of an object or previously present on the surface of the object, or phase information in a plurality of frequency components, and improvement of measurement precision and a dramatic increase in a limit of a measurement scale are achieved.

### TECHNICAL FIELD

The present invention relates to an analysis method, device, and program capable of easily measuring the displacement distribution of an object with high resolution, with high precision, and at a high speed from a regular pattern with arbitrary repetition on the object captured by an optical camera.

### BACKGROUND ART

Technology for measuring displacement distribution of a structure has been widely available from evaluation of the mechanical characteristics of a nano/micro material to evaluation of the health monitoring of a large infrastructure.

A mechanical contact displacement gauge or a non-contact type laser displacement gauge is often used, but only displacement information of one point and one direction is obtained and the displacement gauge is not suitable for recognition of the displacement behavior of an entire structure.

Therefore, a displacement distribution (full-field) measurement method in which displacement distribution in an image captured using an optical camera is obtained is effective.

As a method of displacement distribution measurement using a digital image, there is a digital image correlation (DIC) method, which is currently utilized in many fields.

This DIC method is characterized by use of a random pattern having no regularity.

On the other hand, a method of measuring a small amount of displacement distribution intentionally using a grating pattern with regularity in idea of reversal has also been proposed, as described in Patent Literature 1.

### CITATION LIST

### Patent Literature

[Patent Literature 1] Japanese Patent No. 4831703 Non-Patent Literature
[Non-Patent Literature 1] Chu, T. C., Ranson, W. F. Sutton, M. A. and Peters, W. H., applications of Digital-Image-Correlation Techniques to Experimental Mechanics, Experimental Mechanics, Vol. 25, No. 3 (1985), pp. 232-244.

### SUMMARY OF INVENTION

### Technical Problem

A conventional displacement distribution measurement method using a digital image includes a digital image correlation method using a random pattern often present on a surface of a target or is intentionally painted.

In a displacement distribution measurement technology described in Non-Patent Literature 1, an amount of deformation is calculated by obtaining a correlation of a certain evaluation area (i.e., subset) for a random pattern before and after deformation. However, a large calculation time is required in the case of a high-resolution image.

Further, precision of measurement is limited from 1/20 pixels to 1/50 pixels. Further, it is technically difficult for a target of a nano/micro scale to be painted with any random pattern. There are problems in that it is not easy for a target of a mega scale of a few meters or more to be painted with a random pattern, and time and resources are required. In addition, this is not preferable in terms of (beauty) appearance.

On the other hand, a sampling moire method (Patent Literature 1) capable of measuring a small displacement distribution by generating moire fringes for a fringe image captured by a digital camera using a fringe pattern with regularity and calculating phase information of the moire fringes has been developed.

With this measurement technology, a small displacement distribution can be measured with precision of 1/1000 of a grating pitch affixed to a structure surface. However, a grating used for measurement is a sine wave (or cosine wave) or a rectangular wave pattern in which a white-to-black ratio is 1:1. When a nano/micro material or a large structure is a target, such a pattern is not necessarily affixed to a structure surface and an application is limited. Further, when technology is applied to a regular pattern with two or more cycles of arbitrary repetition, a conventional analysis method has a problem in that a large amount of error is generated.

### Solution to Problem

In order to solve the above problems, the present invention is intended to easily measure displacement distribution, with high precision, and at a high speed using a regular pattern present on a structure surface from a nano scale to a mega scale as shown in FIG. 1. According to a form of a regular pattern image to be analyzed, two displacement distribution measurement methods are considered. Hereinafter, each measurement method will be described.

FIG. 1 shows an example of a pattern having applicable regularity in the present invention, and is not intended to limit the regular pattern.

Further, two methods to be described next are methods suitable for a regular pattern of an object that is a target, but each regular pattern is not limited to the illustrated regular pattern.

(1) Displacement distribution analysis method 1: Displacement distribution analysis method based on an arbitrary analysis pitch using a single higher order frequency

In the present invention, moire fringes are generated based on image data of a one-dimensional regular pattern with repetition with an equal spacing pitch, which is artificially produced on an object surface (for example, affixing of a grating pattern or transferring of the pattern) or previously present on the object surface, and displacement distribution is measured based on phase information on a specific higher order frequency.

This displacement distribution analysis method capable of easily performing higher speed processing can be suitably applied to, more particularly, a regular pattern (for example, a sine wave lattice or a rectangular wave grating that is affixed) having repetition according to a suitable accuracy in measurement in intensity distribution in a horizontal direction or a vertical direction with an equal spacing pitch affixed to the object surface or a regular pattern (for example, vertical or horizontal fringe pattern appearing on an outer wall surface that is a structure of the object) having repetition in which a suitable accuracy in measurement can be expected in the intensity distribution in the horizontal direction or the vertical direction with an equal spacing pitch (p) present on the object surface.

The regular patterns described above are examples of the regular pattern and is not intended to limit an applicable regular pattern of the present invention.

FIG. 2 shows a principle of displacement distribution analysis using an arbitrary analysis pitch that is first method (1), and an image processing method. When a pattern having regularity according to a suitable accuracy in measurement in intensity distribution in a horizontal direction or a vertical direction with an equal spacing pitch affixed to a measurement target surface, such as a sine wave or rectangular wave fringe pattern, is captured by an optical camera, one fringe pattern image having a intensity distribution as expressed by Equation 1 in an approximate manner is obtained.

$$\begin{matrix}[ Equation 1 ] & \\ f ( i , j ) = a cos \{ 2 π \frac{i}{P} + {φ}_{0} ( i , j ) \} + b = a cos \{ φ ( i , j ) \} + b & ( 1 )\end{matrix}$$

Here, f(i, j) denotes an intensity value (brightness) on coordinates (i, j) of a captured image, a denotes an amplitude of the fringe pattern, b denotes background intensity, φ₀ denotes an initial phase of the fringe pattern, and φ is an obtained phase value of the fringe pattern. Further, P denotes a grating pitch spacing in an i-direction on the captured image.

M moire fringe images of which the phase has been shifted are obtained through a process of performing an image thin-out process on one captured fringe grating image while changing, pixel by pixel, a start point m of the decimation for the i-direction at an arbitrary pitch spacing M (which is generally an integer) and performing intensity interpolation using an intensity value of an adjacent image.

$$\begin{matrix}[ Equation 2 ] & \\ \begin{matrix}{f}_{M} ( i , j ; m ) = a cos \{ 2 π ( \frac{1}{P} - \frac{1}{M} ) i + {φ}_{0} ( i , j ) + 2 π \frac{m}{M} \} + b \\ = a cos \{ {φ}_{M} ( i , j ) + 2 π \frac{m}{M} \} + b\end{matrix} & ( 2 )\end{matrix}$$

While the image processing method such as a thin-out process and intensity interpolation described above are the same as that described in Patent Literature 1, a key point is that it is not necessary for the analysis pitch (M; regularity pitch on the image data) to match the pitch spacing (P; equal spacing pitch) of the lattice pattern, and analysis can be performed at arbitrary decimation spacing.

Further, this key point applies to second method.

If discrete Fourier transform shown in Equation 3 is applied to the plurality of moire fringes obtained through the thin-out and the intensity interpolation, phase distribution φ_{M}(i,j; ω) at an arbitrary frequency component (ω) of the moire fringes can be obtained.

$$\begin{matrix}[ Equation 3 ] & \\ {φ}_{M} ( i , j ; ω ) = - arc tan \frac{{\sum }_{m = 0}^{M - 1} {f}_{M} ( i , j ; m ) sin ω ( 2 π \frac{m}{M} )}{{\sum }_{m = 0}^{M - 1} {f}_{M} ( i , j ; m ) cos ω ( 2 π \frac{m}{M} )} & ( 3 )\end{matrix}$$

The same image processing can be performed on the pattern after deformation to similarly obtain phase distribution φ′_{M}(i,j; ω) at an arbitrary frequency component of the moire fringes after deformation. Finally, as shown in Equation 4, displacement distribution u(i, j; ω) in an x-direction can be calculated from a phase difference Δφ_{M}=φ′_{M}−φ_{M} of the moire fringes before and after deformation.

$$\begin{matrix}[ Equation 4 ] & \\ u ( i , j ; ω ) = - \frac{p}{2 π ω} Δ {φ}_{M} ( i , j ; ω ) & ( 4 )\end{matrix}$$

Similarly, when the above-described image processing is performed with respect to y-direction, displacement distribution v(i, j; ω) in the y-direction can be obtained.

(2) Displacement distribution analysis scheme 2: Method of analyzing displacement distribution using an arbitrary regular pattern using a plurality of frequency components

FIG. 3 shows a principle of displacement distribution analysis using arbitrary regular patterns seen in daily life and an image processing method, which is second method (2).

In these regular patterns, the regularity of the patterns is seen differently during visual observation. Accordingly, the regular patterns can be roughly classified into a one-dimensional regular pattern (for example, a tile pattern of an external wall that is a structure of an object or a window pattern of a high-rise building) having two or more cycles of repetition with an equal spacing pitch in a horizontal direction and a vertical direction, which is present or affixed to a surface of an object, and a two-dimensional regular pattern (for example, an arbitrary pattern such as an alphanumeric character or a floral pattern) in which the same pattern has two or more repetitions with an equal spacing pitch in a horizontal direction or a vertical direction, which is present or affixed to a surface of an object, but appropriate processing for image data which is intensity distribution data thereof is the same.

Further, the arbitrary regular pattern seen in daily life described above may refer to a regular pattern with repetition in which a suitable precision in measurement can be expected in intensity distribution at least in a horizontal direction or a vertical direction with an equal spacing pitch, which is present or affixed to the surface of the object.

If the regular pattern having an arbitrary repetition on a measurement target surface is captured by an optical camera, one fringe pattern image having intensity distribution as expressed by Equation 5 is obtained. This is because an arbitrary regular pattern can be expressed by a plurality of Fourier series including a higher order frequency.

$$\begin{matrix}[ Equation 5 ] & \\ g ( i , j ) = {\sum }_{ω = 1}^{W} {a}_{ω} cos ω \{ 2 π \frac{i}{P} + {φ}_{0} ( i , j ) \} + b = {\sum }_{ω = 1}^{W} {a}_{ω} cos ω \{ φ ( i , j ) \} + b & ( 5 )\end{matrix}$$

Here, g(i, j) denotes a intensity value (brightness) on a coordinates (i, j) of a captured image of an arbitrary regular pattern. W denotes an order of a higher order frequency, a_{ω} denotes (a plurality of) amplitudes of the fringe lattice at each frequency, b denotes background intensity, φ₀ denotes an initial phase of the fringe pattern, and φ denotes an obtained phase value of the fringe pattern. Further, P denotes a grating pitch spacing in the i-direction on the captured image.

M moire fringe images of which the phase has been shifted are obtained through a process of performing an image thin-out process on one captured fringe pattern image while changing, pixel by pixel, a start point m of the thin-out for the i-direction at an arbitrary pitch spacing M (which is generally an integer) and performing intensity interpolation using an intensity values of an adjacent image.

$$\begin{matrix}[ Equation 6 ] & \\ \begin{matrix}{g}_{M} ( i , j ; m ) = {\sum }_{ω = 1}^{W} {a}_{ω} cos \{ 2 π ( \frac{1}{P} - \frac{1}{M} ) i + {φ}_{0} ( i , j ) + 2 π \frac{m}{M} \} + b \\ = {\sum }_{ω = 1}^{W} {a}_{ω} cos \{ {φ}_{M} ( i , j ) + 2 π \frac{m}{M} \} + b , ( m = 0 , 1 , … , M - 1 )\end{matrix} & ( 6 )\end{matrix}$$

Since Moire is a kind of enlargement phenomenon, moire fringes having a low spatial frequency obtained here are also regular, and can be represented by Fourier series including a higher order frequency, as shown in Equation 6.

In the present invention, a plurality of frequency components are simultaneously extracted using this property. Amplitude information (or power spectrum information) and phase information of a plurality of frequency components are simultaneously calculated using discrete Fourier transform.

Similarly, the regular pattern after object deformation is captured, the thin-out process and the intensity interpolation are performed, and phase information of the plurality of frequency components of moire fringes after deformation are simultaneously calculated through Fourier transform.

A plurality of displacement distributions u(i, j; ω) in the x-direction can be calculated from the phase difference of the plurality of respective frequencies of the moire fringes before and after deformation using Equation 4. Weighting is performed with obtained final amplitude or power at each frequency and combination is performed so as to obtain final displacement distribution u(i, j).

According to the above method, since a higher order frequency component, as well as a component of frequency 1 that is a fundamental frequency, is considered, it is possible to cope with an arbitrary regular pattern and perform highly accurate displacement distribution measurement with less measurement error.

Similarly, by performing the above-described image processing with respect to a the y-direction, it is possible to obtain the displacement distribution v(i, j) in the y-direction.

### Advantageous Effects of Invention

According to the present invention, if there is a regular pattern with an arbitrary repetition on a surface of a measurement target, it is possible to analyze the displacement distribution easily, with high precision, and at high speed.

As effect 1, it is not necessary to limit the spacing of analysis pitches for the regular pattern, and it is possible to obtain the displacement distribution more easily, with high precision, and at high speed.

As effect 2, since the present invention can be applied to the regular pattern having an arbitrary repetition, an applicable range is wide.

### BRIEF DESCRIPTION OF DRAWINGS

FIG. 1 is a diagram illustrating a regular pattern to which the present invention can be applied.

FIG. 2 is a diagram illustrating a principle of displacement distribution measurement based on an arbitrary analysis pitch for a regular pattern.

FIG. 3 is a diagram illustrating a principle of displacement distribution measurement that uses a regular pattern with arbitrary repetition.

FIG. 4 is a photograph of a 3-point bending experiment apparatus for small deflection distribution measurement of a metal material.

FIG. 5 is a diagram illustrating experimental results of small deflection distribution measurement of a metal material.

FIG. 6 is a diagram illustrating comparison of measurement precision when a one-dimensional regular pattern is used through simulation.

FIG. 7 is a diagram illustrating a simulation result of a relationship between an order of an analysis frequency and a measurement error.

FIG. 8 is a diagram illustrating an optical system for displacement measurement using a one-dimensional regular pattern.

FIG. 9 is a diagram illustrating an experimental result of the displacement measurement using the one-dimensional regular pattern.

FIG. 10 is a diagram illustrating an optical system for displacement measurement using a two-dimensional regular pattern.

FIG. 11 is a diagram illustrating an experimental result of the displacement measurement using the two-dimensional regular pattern.

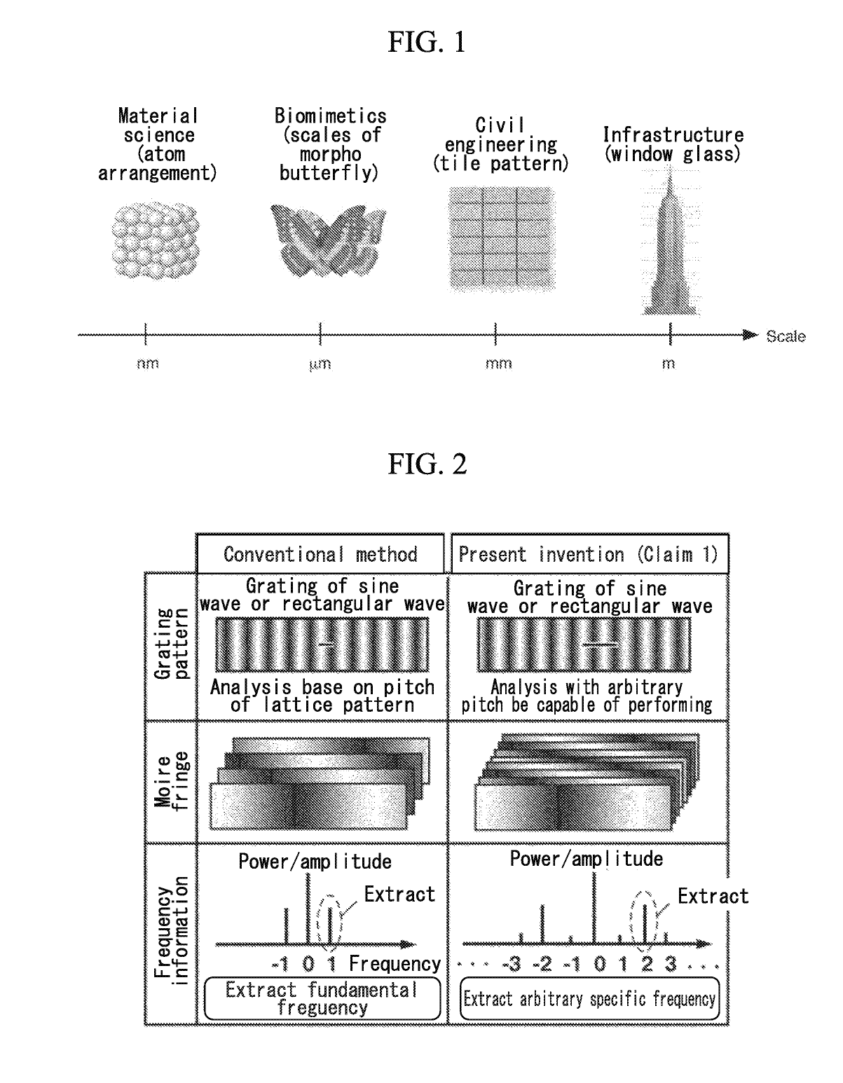

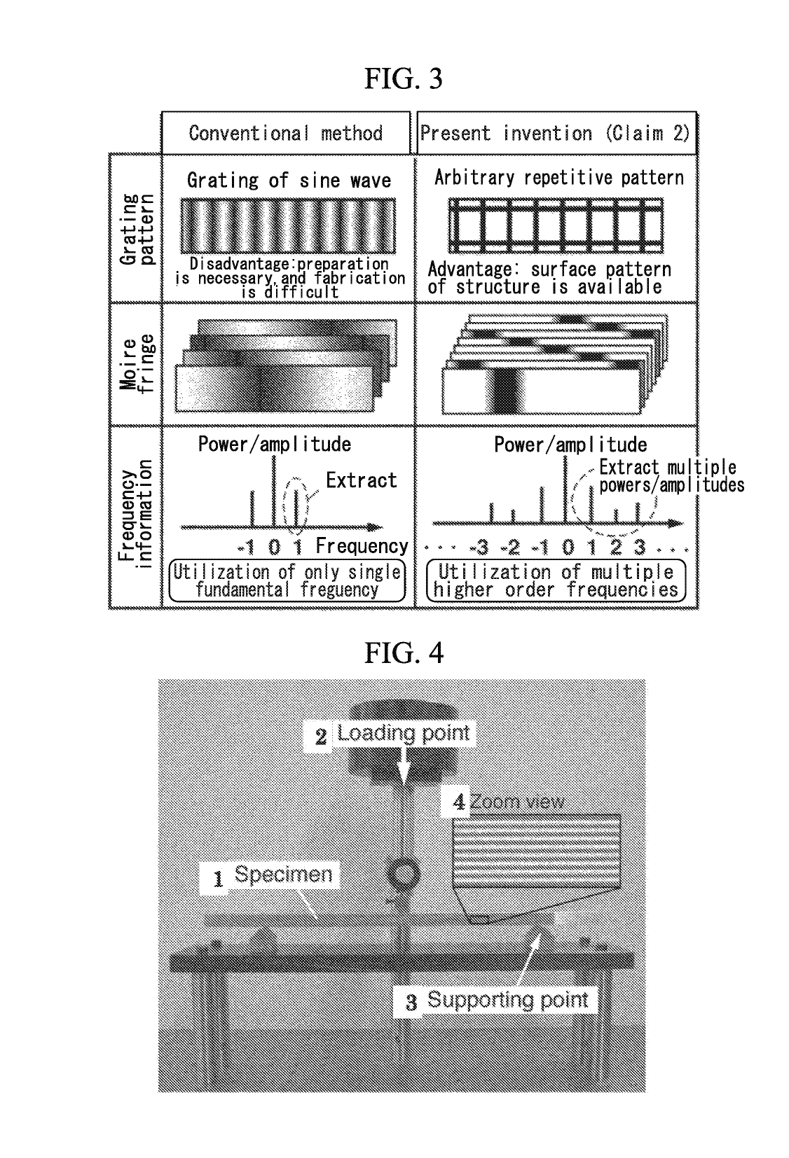

### DESCRIPTION OF EMBODIMENTS

Hereinafter, embodiments of the present invention will be described with reference to the accompanying drawings.

### Example 1

### Improvement of Measurement Precision of Displacement Distribution Based on Single Higher Order Frequency

Experimental results of a metal material 3-point bending test for verifying improvement of displacement measurement precision according to an arbitrary frequency component based on first method (1) of the present invention are shown below. FIG. 4 shows an optical system for the experiment. In this experiment, after a sine wave grating having a pitch spacing of 1.13 mm was affixed to a surface of an aluminum bar having a size of 360×12×12 mm, a load of 9.8 N (1 kg) and 19.6 N (2 kg) was loaded at a center position of which the fulcrum distance was 250 mm, and respective grating images before and after deformation were captured by a general-purpose CCD camera. A camera was installed so that one cycle of the grating pitch is 5 pixels on the captured image.

For the same grating images, deflection distributions obtained by a conventional measurement method (analysis in which a sampling pitch is 5 pixels) and the measurement method of the present invention (analysis in which the sampling pitch is 15 pixels) are compared so as to confirm the validity of the present invention.

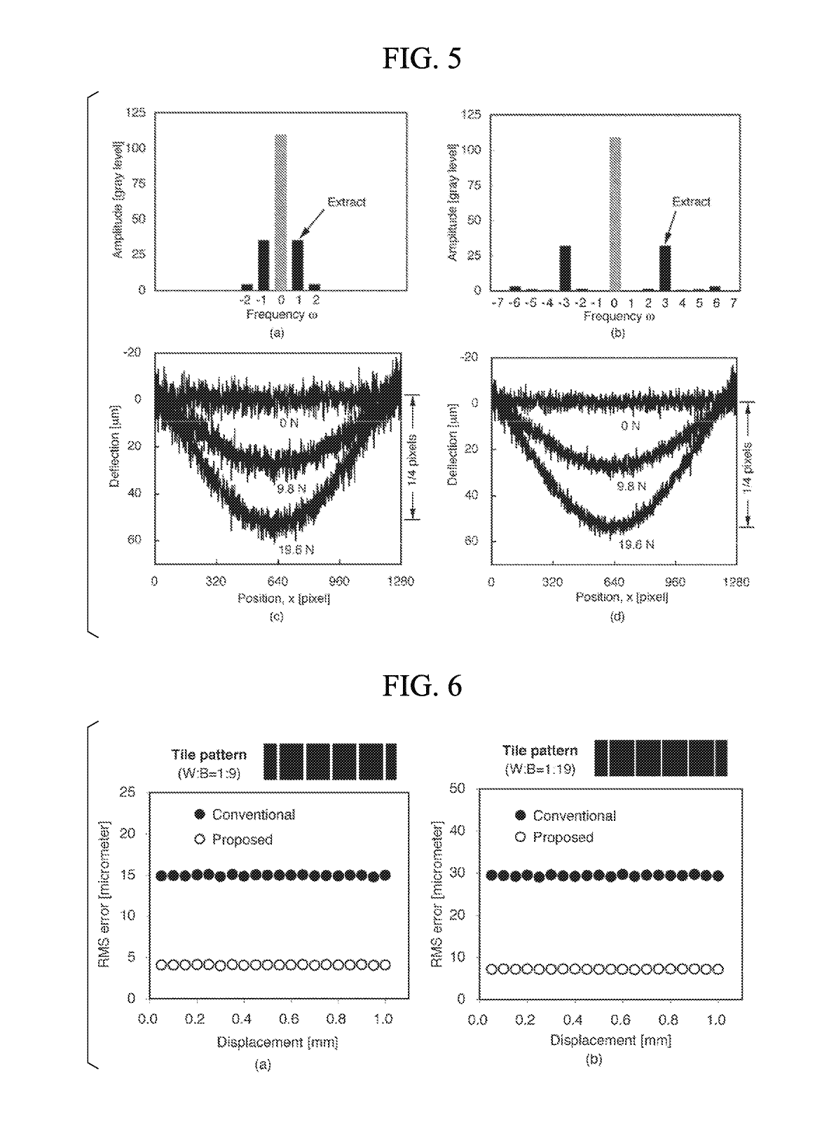

FIG. 5(a) shows a Fourier spectrum distribution in a center pixel near a load point. In the conventional method, since an analysis is performed in which the sampling pitch is about the same width of five pixels that are substantially the same as the grating pitch, large amplitude appears in a component of frequency 1, as shown in FIG. 5(a).

Meanwhile, in the method using the method (1) of the present invention, since the sampling pitch is expanded to three cycles so at to perform analysis, large amplitude appears in a component of frequency 3, as shown in FIG. 5(b).

FIGS. 5(c) and 5(d) show deflection distribution of a horizontal center line measured using the conventional method and the present invention. FIG. 5(c) shows a result of analysis using fundamental frequency 1 in a conventional method, and FIG. 5(d) shows a result of analysis using frequency 3 according to the present invention.

According to the present invention, it was confirmed that the variation of measurement due to random noise of the CCD camera was reduced, and displacement (deflection) distribution with less variation was obtained.

### Example 2

### Verification of Improvement of Displacement Distribution Measurement Precision of Regular Pattern Through Simulation

Effects thereof were confirmed through simulation in order to confirm effectiveness of the method described in the second method (2) of the present invention.

Here, two types of tile patterns of 20 pixels of one cycle (regarded as a grating pitch of 1 mm) in which white is brightness 1 and black is brightness 0 were produced. One of the tile patterns was a tile pattern in which there were 2 white pixels and 18 black pixels among the 20 pixels, and a white-to-black ratio was 1:9. The other was a tile pattern in which there was 1 white pixel and 19 black pixels, and a white-to-black ratio was 1:19. A measurement error when displacement is imparted to two types of grating images by 0.05 mm from 0 mm to 1 mm on a computer was investigated.

Analysis of an amount of displacement was performed in a state in which random noise of 10% was applied to a tile pattern image at each position in consideration of noise generated in elements of a digital camera at the time of actual measurement. In the analysis, a thin-out number (sampling pitch) was set to 20 pixels, and a result of analyzing only frequency 1 described in Patent Literature 1 of the related art and a result of analysis in consideration fundamental frequency component and first to fifth order frequency components according to the present invention were compared.

FIG. 6 shows a relationship between an amount of displacement and an analysis error with respect to two types of tile patterns having different white-to-black ratios. Here, a root mean square (RMS) error of a difference between an analyzed amount of displacement and a theoretical amount of displacement in an evaluation area of 20×20 pixels at a center of the image.

It was confirmed that in the tile pattern with the white-to-black ratio of 1:9, the noise reduction in the conventional method was 14.9 μm, whereas the noise reduction according to the present invention was 4.1 μm, and there is an effect of noise reduction of ⅓ or more, as shown in FIG. 6.

It was confirmed that in the tile pattern with the white-to-black ratio of 1:19, the analysis error in the conventional method was 29.4 μm, whereas the analysis error according to the present invention was 7.2 μm, which was ¼ or less of the analysis error in the conventional method, and the precision could be improved.

From this simulation, it was confirmed that, for an arbitrary regular pattern, by considering a plurality of higher order frequency components, random noise could be greatly reduced, and stable displacement measurement was performed with slight variation.

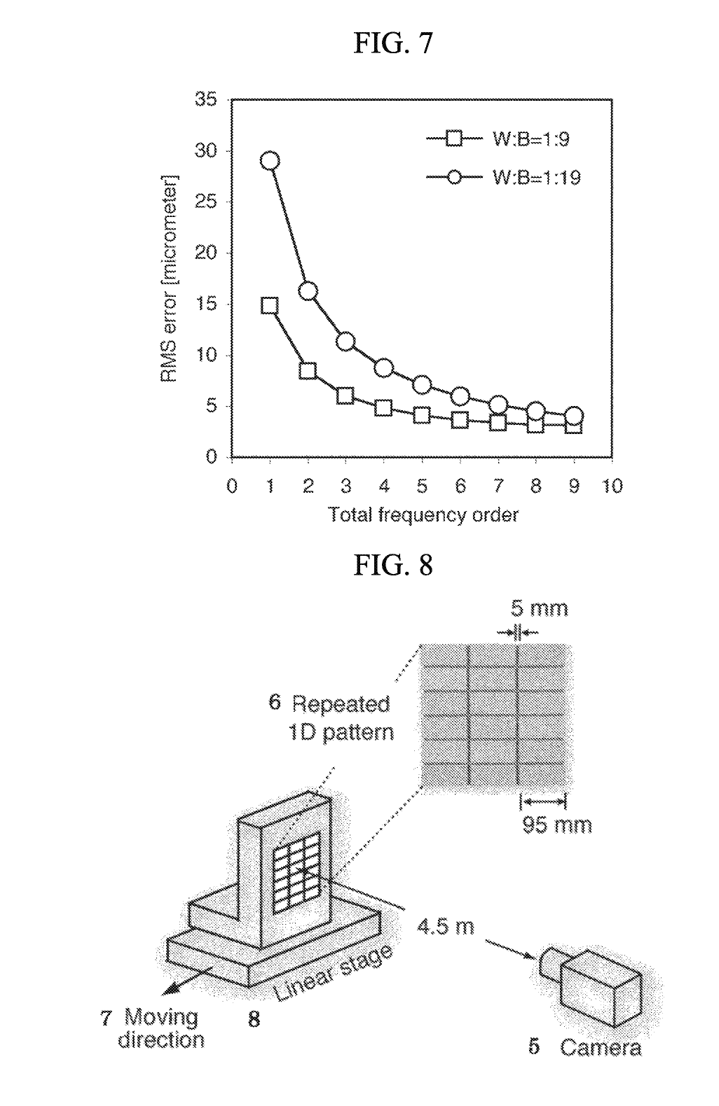

FIG. 7 shows a relationship between orders of the frequency used for analysis and a measurement error in the present invention. It can be seen from this that it is possible to improve the measurement precision by considering a plurality of frequency components as compared with the conventional method that uses only a component of frequency 1.

### Example 3

### Verification of Improvement of Displacement Distribution Measurement Precision of One-Dimensional Regular Pattern Through Experiment

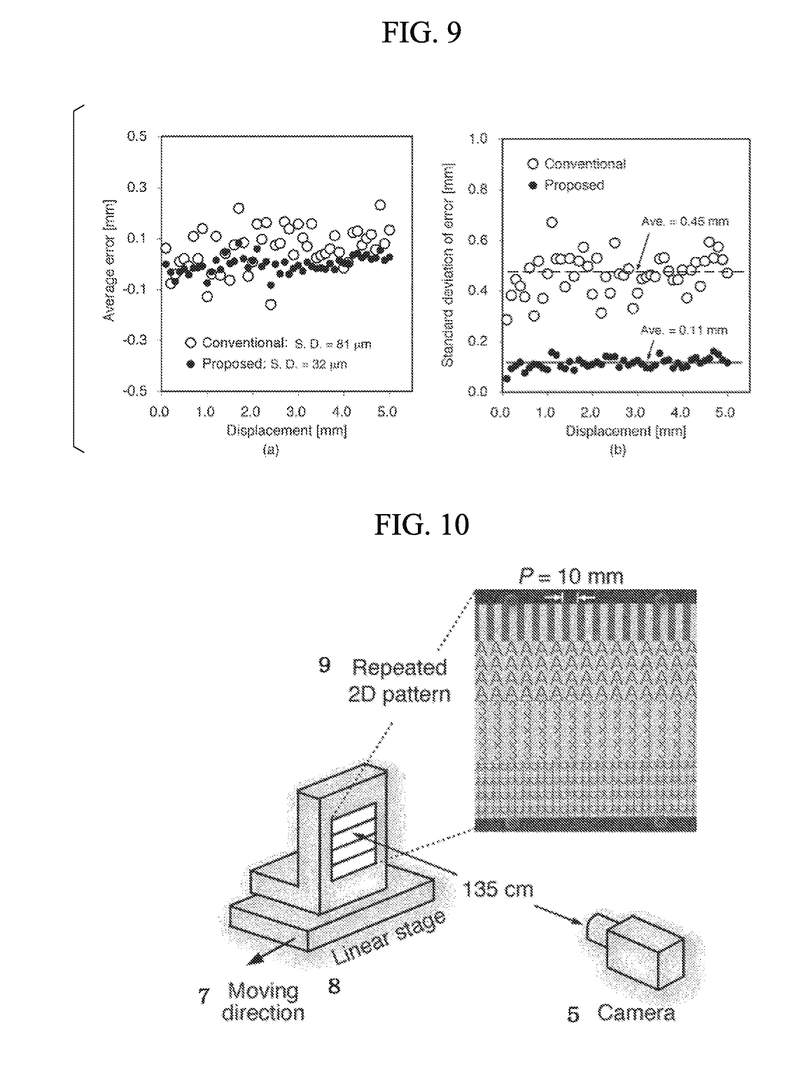

FIG. 9 shows experimental results of displacement distribution analysis using a tile pattern having one-dimensional regularity using the optical system illustrated in FIG. 8 in order to confirm effectiveness of the method described in the second method (2) of the present invention.

In this experiment, an actual tile having a width of 95 mm and a spacing of 5 mm was used. In this case, a white-to-black ratio was 1:19, which was the same white-to-black ratio as that of one tile pattern of the simulation in Example 2.

This tile was fixed onto a flat plate of a liner moving stage, and an image capturing was performed using an optical camera installed at a place separated from 4.5 m.

In this case, a grating pitch on a camera image was 40 pixels. The tile was moved in a horizontal direction by 0.1 mm step from 0 mm to 2 mm from the moving stage, an image was captured at each position (moving distance), and amounts of displacement in a conventional method that uses only a first order frequency component and the present invention that considers fundamental frequency component and first to fifth order frequency components were analyzed so as to calculate an average value of experimental data in the evaluation area of 40×10 pixels at a center of the image and a measurement error of an amount of the displacement of the stage, and a standard deviation thereof.

FIG. 9(a) shows an average error obtained using the conventional method and the present invention with respect to a moving distance. It can be seen from this experimental result that, according to the present invention, high-precision displacement measurement was performed.

FIG. 9(b) shows a standard deviation of a measurement error obtained using the conventional method and the present invention with respect to the moving distance. It was possible to reduce to less than a quarter of variation as compared with the conventional method.

### Example 4

### Verification of Improvement of Displacement Distribution Measurement Precision of Two-Dimensional Regular Pattern Through Experiment

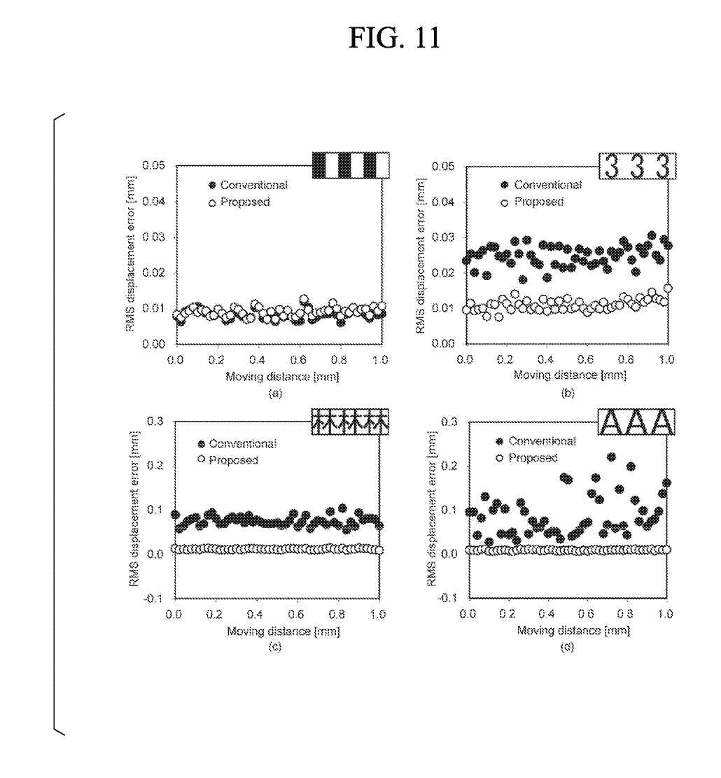

Experimental results of displacement distribution analysis using a pattern having a two-dimensional regularity using an optical system shown in FIG. 10 in order to confirm effectiveness of the method described in the second method (2) of the present invention are shown in FIG. 11.

In this experiment, three types of two-dimensional regular patterns such as The letter “A”, number “3”, and Chinese character “ [symbol] ” having a pitch spacing of 10 mm in addition to the square wave pattern used in a conventional method (for comparison with the present invention) were used.

The four types of patterns were fixed onto the flat plate of the linear moving stage, and image capturing was performed using an optical camera installed at a place separated from 1350 mm.

In this case, a grating pitch on a camera image was 20 pixels. The pattern was moved in a horizontal direction by 0.02 mm from 0 mm to 1 mm from the linear moving stage, and an image at each position (a moving distance) was captured. Amounts of displacement according to a conventional method that uses only a first order frequency component and the present invention considering the fundamental frequency component and first to fifth order frequency components were analyzed respectively, and a root mean square (RMS) of a measurement error of the experimental value in an evaluation area of 20×20 pixels at a center of the image and an amount of displacement of the stage was calculated.

FIG. 11 shows an RMS error obtained using the conventional method and the present invention with respect to the moving distance. With any of three types of two-dimensional regular patterns, significant improvement of the measurement precision was achieved.

Specifically, in the case of the repetitive regular pattern of number “3”, the RMS average error of the conventional method was 26.3 μm, whereas the RMS average error of the present invention was 12.1 p.m. The measurement precision could be improved by 2.2 times.

In the case of the repetitive regular pattern of Chinese character “*”, the RMS average error of the conventional method was 76.6 μm, whereas the RMS average error of the present invention was 12.2 μm. The measurement precision could be improved by 6.3 times.

In the case of a repetitive regular pattern of the letter “A”, the RMS average error of the conventional method was 112.4 μm, whereas the RMS average error of the present invention was 10.0 μm. The measurement precision could be improved by 11.2 times.

On the other hand, in the case of a rectangular wave pattern used in the conventional method, the RMS average error of the conventional method was 8.7 μm, whereas the RMS average error of the present invention was 9.6 μm. The same degree of measurement precision was achieved.

According to the present invention, with respect to any of the three types of two-dimensional regular patterns used in this experiment, the measurement of a small amount of displacement distribution with the measurement precision of about 10 μM was achieved.

This is a surprisingly high measurement precision that is indeed 1/1000 of 10 mm that is a pattern pitch. That is, if an atomic arrangement pattern of a nano scale observed by an electron microscope is analyzed, displacement distribution of sub-Angstrom order that is smaller than atoms can be theoretically analyzed.

On the other hand, by regarding window glass of a high-rise building arranged with spacings of one meter as a regular pattern and analyzing the window glass, shaking or deflecting of the entire building can be detected with precision of mm order only by capturing the building using the optical camera from a distance.

### Example 5

In the above example, the program was produced using C (programming language) and C⁺⁺ (programming language) and each displacement distribution measurement method was executed so as to measure the displacement distribution.

The program language is not limited to C and C⁺⁺, and the program may be a program loaded into a RAM or may be a program fixed in a ROM.

### Example 6

In the above-described example, the image data obtained from the optical camera was processed using a personal computer so as to obtain a measurement result of each displacement distribution.

The displacement distribution measurement device may be formed separately from the optical camera, or may be formed integrally with the optical camera.

Further, the displacement distribution measurement device may be incorporated in a displacement distribution analysis device, or may be incorporated in various measurement devices by setting appropriate input and output specifications and integration into one chip of the displacement distribution measurement device.

### INDUSTRIAL APPLICABILITY

Since the present invention can be applied to an arbitrary regular pattern, the present invention is suitably applied to evaluation of mechanical characteristics of a newly developed material or diagnosis of health monitoring of an infrastructure. Objects having wide range from a nano/micro scale to a mega scale can be a analysis target of the present invention.

More specifically, industrial fields to which the present invention can be applied and deployed may include fields of nano-science, mechanical material, infrastructure civil engineering, and biomimetics.

### REFERENCE SIGNS LIST

1 sample
2 load mechanism
3 support
4 enlarged view of grating pattern
5 camera
6 one-dimensional repetitive pattern
7 moving direction
8 linear moving stage

1. A method for measuring displacement distribution of an object by capturing a digital image before and after deformation of a regular pattern such as a sine wave or a rectangular wave grating being affixed to an object surface and having repetition according to desired measurement precision in intensity distribution in a horizontal direction or a vertical direction with an equal spacing pitch or a regular pattern such as vertical or horizontal fringe pattern appearing on an outer wall surface that is a structure of the object presenting on the object surface and having repetition in which a suitable precision in measurement can be expected in the intensity distribution in the horizontal direction or the vertical direction with an equal spacing pitch using an optical camera, and processing the digital image in a displacement distribution measurement device, the method comprising steps of:
acquiring a pattern image before and after the deformation;
performing a thin-out process and intensity interpolation at arbitrary fixed sampling intervals which is equivalent to an analysis frequency and may not match a pitch of the regular pattern in the horizontal direction or the vertical direction on intensity data of the pattern image, and generating a plurality of moire fringe images with a low spatial frequency of which the phase is shifted;
performing a Fourier transform on a moire fringe image of which the phase is shifted, extracting information on a specific frequency component such as a component with maximum amplitude or power corresponding to the analysis frequency, and obtaining phase distribution of moire fringe images of a fundamental frequency in which the analysis frequency and the pitch of the regular pattern are assumed not to match each other or a higher order frequency in the horizontal direction or the vertical direction; and
calculating the displacement distribution of the object from phase difference distribution obtained from phase distributions of the moire fringes before and after the deformation,
wherein an equation for obtaining a displacement distribution u from the phase difference distribution at the specific frequency ω of the moire fringes is shown as;
[Equation 1]
$$\begin{matrix}[ Equation 7 ] & \\ u ( i , j ; ω ) = - \frac{p}{2 π ω} Δ {φ}_{M} ( i , j ; ω ) & ( 7 )\end{matrix}$$
in which i and j denote a horizontal coordinate and a vertical coordinate of the captured image, p denotes an actual value of a pitch spacing of the regular pattern in the horizontal direction or the vertical direction, M denotes the analysis frequency, ω denotes the fundamental frequency in which the analysis frequency and the pitch of the regular pattern are assumed not to match each other or the higher order frequency, and φ denotes a phase distribution function.

2. A method for measuring displacement distribution of an object by capturing a digital image before and after deformation of a one-dimensional regular pattern such as a tile pattern of an external wall that is a structure of an object or a window pattern of a high-rise building having two or more cycles of repetition with an equal spacing pitch in a horizontal direction and a vertical direction present or affixed on a surface of an object using an optical camera, and processing the digital image in a displacement distribution measurement device, the method comprising steps of:
acquiring a one-dimensional regular pattern image before and after the deformation;
performing a thin-out process and intensity interpolation at arbitrary fixed sampling intervals which is equivalent to an analysis frequency and may not match a pitch of the regular pattern in the horizontal direction or the vertical direction on intensity data of the one-dimensional regular pattern image to generate a plurality of moire fringe images of which the phase is shifted;
performing a Fourier transform on the moire fringe image of which the phase is shifted, simultaneously extracting information on a plurality of a frequency components corresponding to the analysis frequency, and obtaining phase distribution of the moire fringe image of a plurality of frequencies in the horizontal direction or the vertical direction; and
performing weighting with amplitude or power at each frequency and combination based on a plurality of phase difference distributions obtained from phase distribution of the moire fringes before and after the deformation, and calculating the displacement distribution of the object with a small measurement error for a predetermined repetitive pattern.

3. A method for measuring displacement distribution of an object by capturing a digital image before and after deformation of a two-dimensional regular pattern such as an arbitrary pattern of an alphanumeric character or a floral pattern in which the same pattern has two or more repetitions with an equal spacing pitch in a horizontal direction or a vertical direction present or affixed on a surface of an object using an optical camera, and processing the digital image in a displacement distribution measurement device, the method comprising steps of:
acquiring a two-dimensional regular pattern image before and after the deformation;
performing a thin-out process and intensity interpolation at arbitrary fixed sampling intervals which is equivalent to an analysis frequency and may not match a pitch of the regular pattern in the horizontal direction or the vertical direction on intensity data of the two-dimensional regular pattern image to generate a plurality of moire fringe images of which the phase is shifted;
performing a Fourier transform on the moire fringe image of which the phase is shifted, simultaneously extracting information on a plurality of a frequency components corresponding to the analysis frequency, and obtaining phase distribution of the moire fringe image of a plurality of frequencies in the horizontal direction or the vertical direction; and
performing weighting with amplitude or power at each frequency and combination based on a plurality of phase difference distributions obtained from phase distribution of the moire fringes before and after the deformation, and calculating the displacement distribution of the object with a small measurement error for a predetermined repetitive pattern.

4. A method for measuring displacement distribution of an object by capturing a digital image before and after deformation of a regular pattern with repetition in which desired measurement precision is able to be expected in intensity distribution at least in a horizontal direction or a vertical direction with an equal spacing pitch present or affixed on the surface of the object using an optical camera, and processing the digital image in a displacement distribution measurement device, the method comprising steps of:
acquiring a regular pattern image before and after the deformation;
performing a thin-out process and intensity interpolation at arbitrary fixed sampling intervals which is equivalent to an analysis frequency and may not match a pitch of the regular pattern in the horizontal direction or the vertical direction on intensity data of the regular pattern image to generate a plurality of moire fringe images of which the phase is shifted;
performing Fourier transform on the moire fringe image of which the phase is shifted, simultaneously extracting information on a plurality of a frequency components corresponding to the analysis frequency, and obtaining phase distribution of the moire fringe image of a plurality of frequencies in the horizontal direction or the vertical direction; and
performing weighting with amplitude or power at each frequency and combination based on a plurality of phase difference distributions obtained from phase distribution of the moire fringes before and after the deformation, and calculating the displacement distribution of the object with a small measurement error for a predetermined repetitive pattern.

5. A computer-readable recording medium having a program recorded thereon, wherein steps according to claim 1 are executed in an object displacement distribution analysis program.

6. A computer-readable recording medium having a program recorded thereon, wherein steps according to claim 2 are executed in an object displacement distribution analysis program.

7. A computer-readable recording medium having a program recorded thereon, wherein steps according to claim 3 are executed in an object displacement distribution analysis program.

8. A computer-readable recording medium having a program recorded thereon, wherein steps according to claim 4 are executed in an object displacement distribution analysis program.

9. A device for measuring displacement distribution of an object,
wherein the device measures displacement distribution of the object by performing the method according to claim 1.

10. A device for measuring displacement distribution of an object,
wherein the device measures displacement distribution of the object by performing the method according to claim 2.

11. A device for measuring displacement distribution of an object,
wherein the device measures displacement distribution of the object by performing the method according to claim 3.

12. A device for measuring displacement distribution of an object,
wherein the device measures displacement distribution of the object by performing the method according to claim 4.
